(19) United States
(12) Patent Application Publication
(10) Pub. No.: US 2013/0223682 A1
(43) Pub. Date: Aug. 29, 2013

(54) ARTICLE RECOGNITION SYSTEM AND ARTICLE RECOGNITION METHOD

(71) Applicant: Toshiba Tec Kabushiki Kaisha, (US)

(72) Inventors: Hiroshi SUGASAWA, Miyagi (JP); Hitoshi IIZAKA, Shizuoka (JP); Hidehiro NAITO, Shizuoka (JP)

(73) Assignee: Toshiba Tec Kabushiki Kaisha, Tokyo (JP)

(21) Appl. No.: 13/773,287

(22) Filed: Feb. 21, 2013

(30) Foreign Application Priority Data
Feb. 29, 2012 (JP) 2012-044238

(51) Int. Cl. G06K 9/32

(52) U.S. Cl. CPC G06K 9/3241
USPC 382/103

(57) ABSTRACT

According to embodiments, an article recognition system is disclosed. The article recognition system comprises an image sensor configured to capture an image of an article, and a determining module configured to determine a value indicative of darkness of the captured image and compare the determined value with a reference value. The article recognition system further comprises a changing module configured to change the reference value when the determined value is less than the reference value, and an extracting module configured to identify the article on the basis of the captured image when the determined value is greater than the reference value.

### CROSS-REFERENCE TO RELATED APPLICATION

This application is based upon and claims the benefit of priority from Japanese Patent Application No. 2012-044238, filed on Feb. 29, 2012, the entire contents of which are incorporated herein by reference.

### FIELD

Embodiments described herein relate generally to a system wherein an article is recognized from image data, and the type of the article is identified.

### BACKGROUND

The recognition technology whereby an article is recognized from image data has not been adopted in practical applications. According to this recognition technology, by using an algorithm of the pattern matching method, minutiae method, frequency analysis method, etc., characteristic quantities of the image data are compared with dictionary data. In the recent years, studies have been conducted on the application of recognition technology on scanners in supermarkets, and the like.

### DESCRIPTION OF THE DRAWINGS

FIG. 1 is a diagram illustrating the appearance of the checkout system of a first embodiment.

FIG. 2 is a hardware block diagram illustrating a POS terminal and a commodity reader in the first embodiment.

FIG. 3 is a schematic diagram illustrating the data constitution of a PLU file in the first embodiment.

FIG. 4 is a functional block diagram illustrating a program executed by the POS terminal and commodity reader in the first embodiment.

FIG. 5 is a diagram illustrating the constitution of a check table in the first embodiment.

FIG. 6 is a diagram illustrating a default GUI in the first embodiment.

FIG. 7 is a diagram illustrating a GUI for requesting the operator to make a confirmation in the first embodiment.

FIG. 8 is a diagram illustrating a GUI for requesting the operator to make a confirmation in the first embodiment.

FIG. 9 is a diagram illustrating a GUI for requesting the operator to make a selection in the first embodiment.

FIG. 10 is a diagram illustrating a flow chart executed by the commodity reader in the first embodiment.

FIG. 11 is a diagram continuing the flow chart of FIG. 10.

FIG. 12 is a diagram illustrating a flow chart executed by the POS terminal in the first embodiment.

FIG. 13 is a diagram illustrating the appearance of a self-checkout device of a second embodiment.

FIG. 14 is a block diagram illustrating the hardware components of the self-checkout device of the second embodiment.

### DETAILED DESCRIPTION

According to embodiments, an article recognition system is disclosed. The article recognition system comprises an image sensor configured to capture an image of an article, and a determining module configured to determine a value indicative of darkness of the captured image and compare the determined value with a reference value. The article recognition system further comprises a changing module configured to change the reference value when the determined value is less than the reference value, and an extracting module configured to identify the article on the basis of the captured image when the determined value is greater than the reference value.

According to additional embodiments, an article recognition system is disclosed. The article recognition system comprises an retrieving module configured to retrieve an image of an article captured by an image sensor, and a determining module configured to determine a value indicative of darkness of the retrieved image and compare the determined value with a reference value. The article recognition system further comprises a changing module configured to change the reference value when the determined value is less than the reference value, and an extracting module configured to identify the article on the basis of the retrieved image when the determined value is greater than the reference value.

According to additional embodiments, an article recognition method is disclosed. The article recognition method comprises obtaining an image of an article captured by an image sensor, determining a value indicative of darkness of the captured image, and comparing the determined value with a reference value. The article recognition method further comprises changing the reference value when the determined value is less than the reference value, and identifying the article based on the obtained image when the determined value is greater than the reference value.

Hereinafter, the embodiments will be described with reference to the drawings. In the drawings, the same reference numerals denote the same or similar portions respectively.

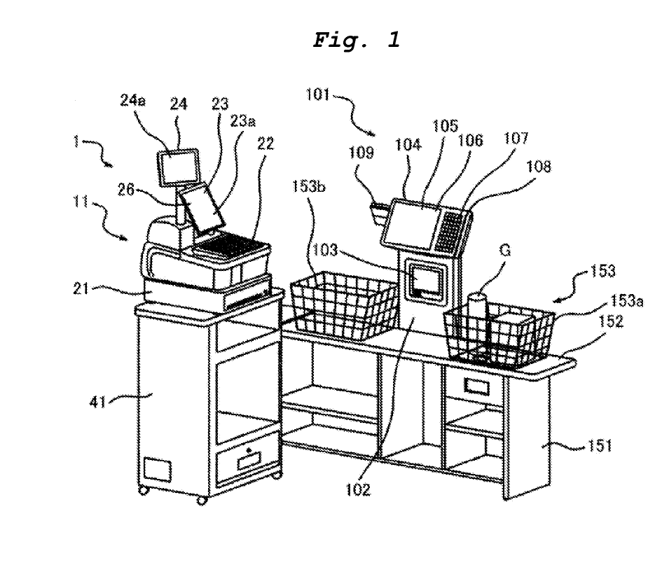

The first embodiment will be described with reference to FIG. 1 through FIG. 12 and is an application example of a checkout system in the retail setting of a supermarket.

FIG. 1 is a diagram illustrating the appearance of the checkout system 1 in the first embodiment. Here, the checkout system 1 has a POS terminal 11, a counter 151, and a commodity reader 101. The checkout table 41 has a POS terminal 11 and a drawer 21 in its upper portion. The drawer 21 has a space inside it for accommodating coins and banknotes. This drawer 21 works under the signal from the POS terminal 11.

The POS terminal 11 has a keyboard 22, a display device 23, and a display device 24. The keyboard 22 is an input device for receiving the instructions from the operator. The display device 23 mainly displays information for the operator to view. This display device 23 has a touch panel 26 on its surface 23a. The touch panel 26 detects a position of the operator's touch. The display device 24 mainly displays the information for the customer. The display device 24 may also have a touch panel on its surface 24a. The POS terminal 11 supports the display device 24 in a rotatable way. The operator can turn the display device to the desired direction.

The commodity reader 101 is set on the counter 151. The commodity reader 101 can conduct data transmission/reception with the POS terminal 11. The counter 151 has an elongated shape along the customer passage. The customer moves along the counter 151. The checkout table 41 is set adjacent to the counter 151 on the downstream side in the direction of the customer. The salesperson operates the commodity reader 101 and the POS terminal 11 in the space surrounded by the counter 151 and checkout table 41.

The commodity reader 101 has a housing 102. The housing 102 has a reading window 103 on its front side, a commodity reading unit 110 inside, and a light source not shown in FIG. 1. The light source is arranged near the reading window 103 and illuminates the commodity. The commodity reading unit 110 has an image sensor 164. The image sensor 164 detects the light incident from the reading window 103 and converts the light into the image data.

The housing 102 has an input/output unit 104 in its upper portion. The input/output unit 104 has a display device 106, a keyboard 107, a slot 108, and a display device 109. The display device 106 has a touch panel 105 on its surface. This display device 106 mainly displays information for the operator to view. The slot 108 has a card reader inside of it for reading the magnetic portion of the credit card. The display device 109 displays information for the customer to view.

The customer sets the shopping basket 153a on a side of the commodity reader 101 and on the upper surface 152 of the counter 151. The operator sets an empty shopping basket 153b on the other side of the commodity reader 101. The operator then takes out commodity G from the shopping basket 153a and moves the commodity G to the front side of the reading window 103. The image sensor 164 then collects the image data of the commodity G through the reading window 103. After the image sensor 164 has gathered the image data, the operator loads the commodity G into the shopping basket 153b that has been prepared beforehand. Through the operator's actions, the commodity reader 101 acquires the image data of the commodity.

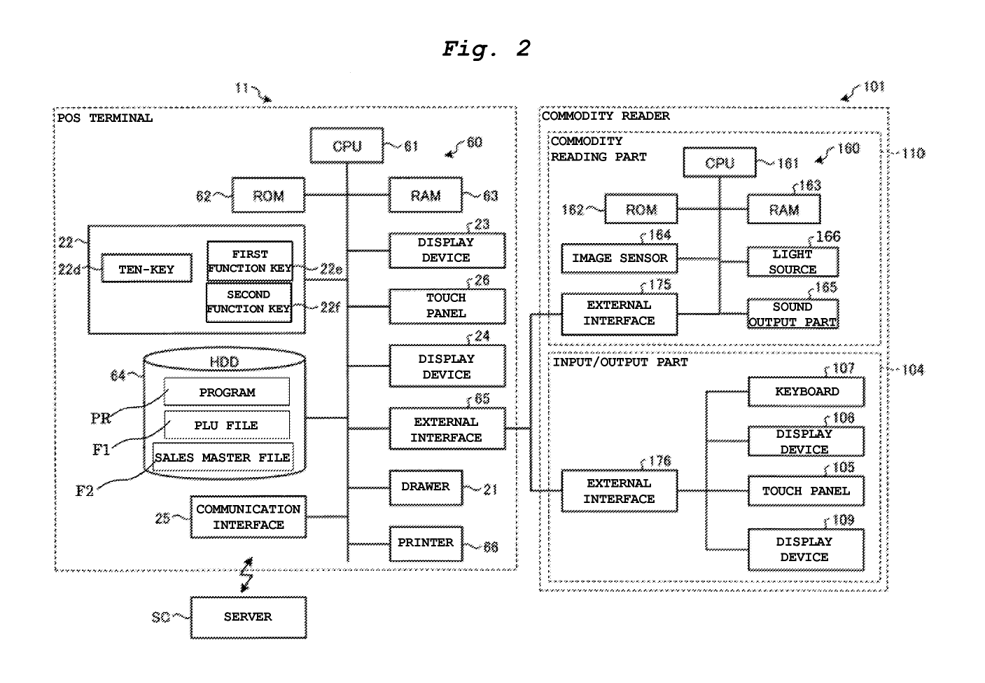

FIG. 2 is a block diagram illustrating the hardware of the POS terminal 11 and the commodity reader 101. The POS terminal 11 has a microcomputer 60 for processing the information. The microcomputer 60 has a CPU (Central Processing Unit) 61, a ROM (Read-Only Memory) 62, and a RAM (Random Access Memory) 63. The signal lines provide for data communication between the CPU 61, ROM 62, and RAM 63.

The microcomputer 60 communicates with the drawer 21, the keyboard 22, the display device 23, the display device 24, the touch panel 26, the HDD (Hard Disk Device) 64, the printer 66, the communication interface 25, and the external interface 65.

The keyboard 22 has, at a minimum, a ten-key 22d, a first function key 22e, and a second function key 22f. The ten-key 22d has plural numeral keys and operator keys. The printer 66 prints the receipt information on a roll paper for the customer.

The HDD 64 stores the application program PR and various data. The PLU file F1 is among this data. The CPU 61 copies the application program PR into the RAM 63 when the POS terminal 11 is started. The CPU 61 executes the application program PR stored in the RAM 63. On the basis of the request of the application program PR, the CPU 61 reads the data stored in the HDD 64.

The external interface 65 is connected to the commodity reader 101. The communication interface 25 is connected to the server CS via a network. The server CS includes a HDD that stores the master file of the PLU file F1. The POS terminal 11 performs regular synchronization between the master file and the PLU file F1.

The commodity reader 101 has a commodity reading unit 110 and an input/output module 104. The commodity reading unit 110 includes a microcomputer 160, an image sensor 164, a sound output module 165, a light source 166, and an external interface 175. The microcomputer 160 controls the image sensor 164, the sound output module 165 and the external interface 175. The microcomputer 160 includes a CPU 161, a ROM 162, and a RAM 163. The signal lines connect the CPU 161, the ROM 162, and the RAM 163 with each other. The RAM 163 stores the program executed by the CPU 161.

The image sensor 164 may include a color CCD system and a color CMOS system, or the like. The image sensor 164 can continuously generate the image data at, for example, a frame rate of 30 fps, and the RAM 163 stores the image data. In this embodiment, the image data are defined as frame images. In the following, the frame images will be represented as FI(n) in the order of their generation time. Here, n is an integer, and FI(2) represents a frame image generated after FI(1).

The sound output module 165 includes a sound circuit, a speaker, etc. The sound circuit includes an alarm sound and a voice message pre-stored in the RAM 163. The sound circuit converts the alarm sound and the voice message to an analog signal. The speaker converts the analog signal generated by the sound circuit to a sound and outputs the sound.

The input/output module 104 includes a touch panel 105, a display device 106, a display device 109, a keyboard 107, and an external interface 176. The external interface 176 connects the input/output module 104 to the commodity reading unit 110 and the POS terminal 11.

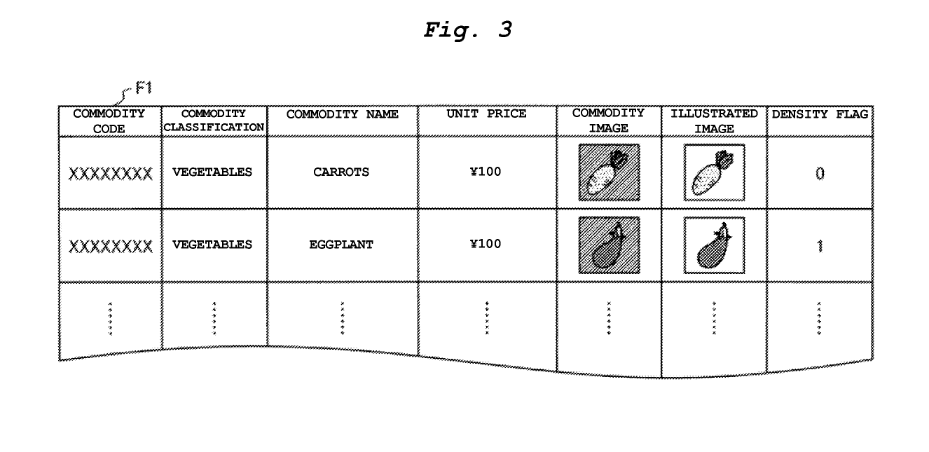

FIG. 3 is a schematic diagram illustrating the data format of the PLU file F1. This PLU file F1 is a Price Look Up table that having data in SQL language. The record of the PLU file F1 includes plural field values. The PLU file F1 includes, at minimum, the following field values: the commodity code, the commodity classification, the commodity name, the unit price, the commodity image, the illustration image, and the density flag. The commodity code is a unique ID for specifying the commodity G. This commodity code may contain the unique ID defined as UPC (the Universal Product Code), EAN (European Article Number), or JAN (Japanese Article Number). The PLU file F1 is a collection of plural records with the commodity code as the principal key, i.e., a unique ID for specifying the record within the same file.

The commodity classification indicates the category of the commodity, such as fruits, vegetables, etc. The commodity image refers to the image data of the commodity taken by a digital camera. The CPU 161 compares the commodity image with the frame image generated by the image sensor 164 and calculates the similarity between them. The commodity image is a reference data for specifying the commodity G. According to the first embodiment, the reference data is not limited to the image data. The reference data may also be the characteristic quality data. The characteristic quantity data refers to the data calculated from the surface bumps/dips, surface pattern, hue, and the like, of the commodity G.

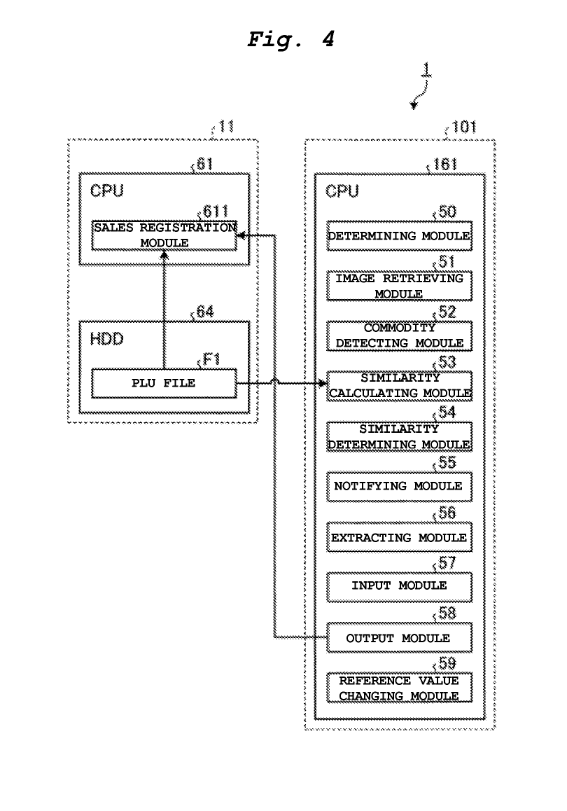

FIG. 4 is a diagram illustrating the function blocks of the programs executed by the POS terminal 11 and the commodity reader 101. The program executed by the CPU 161 of the commodity reader 101 includes a deciding module 50, an image-retrieving module 51, a commodity-detecting module 52, a similarity-calculating module 53, a similarity determining module 54, a notifying module 55, an extracting module 56, an input module 57, an output module 58, and a reference value changing module 59. The ROM 162 stores the program. The program PR executed by the CPU 61 of the POS terminal 11 includes the sales registration module 611.

The image retrieving module 51 outputs an ON signal to the image sensor 164. The image sensor 164 then starts the image pickup operation. The image sensor 164 sends the frame images to the RAM 163. The image-retrieving module 51 sequentially retrieves the frame images stored in the RAM 163. The image-retrieving module 51 retrieves the frame images in order, such as frame image FI(1) and then frame image FI(2).

The image-retrieving module 51 detects the change in the brightness of the frame image. When there is no commodity in front of the reading window 103, the brightness of the frame image is zero or near zero. On the other hand, when a commodity is in front of the reading window 103, the light emitted from the light source 166 is reflected by the commodity and is input to the image sensor 164. Consequently, the brightness of the frame image FI(n) increases. When the brightness of the frame image FI(n) changes, the CPU 161 starts the other function blocks, and the load of the CPU 161 is reduced.

In the following, the other function blocks will be defined as the object recognition engine. The object recognition engine includes, but is not limited to, the deciding module 50, the commodity-detecting module 52, the similarity-calculating module 53, the similarity determining module 54, the notifying module 55, the extracting module 56, the input module 57, the output module 58, and the reference value-changing module 59.

After it is determined that the brightness is greater than the reference value, the image-retrieving module 51 starts the object recognition engine. The commodity reader 101 may be set for various different environments. For example, the reference value of the brightness may be set corresponding to the external disturbance of the environment. Alternatively, the reference value may be set on the basis of the reference image to be explained later.

The image-retrieving module 51 may detect the change in the frame images on the basis of the brightness, saturation, hue, or a combination of these factors. The brightness, saturation and hue are usually called the attributes of color.

The reference value-changing module 59 changes the reference value of the brightness. When the image retrieving module 51 detects a change in the brightness, if the brightness of the frame image is less than the reference value, the reference value-changing module 59 decreases the reference value of the brightness. As the reference value of the brightness is decreased, the object recognition engine can start treatment of the commodity having a dark color on its surface.

The reference value changing module 59 may also change the reference value of the color attributes. The reference value changing module 59 may change the output power of the light source. A change of the reference value may also include change in the output power of the light source.

The commodity-detecting module 52 detects the commodity G contained in the frame image according to pattern-matching technology or the like. Specifically, the commodity-detecting module 52 extracts the contour line from the binary data of the frame image FI(m). Then, the commodity-detecting module 52 extracts the contour line from the binary data of the frame image FI(m-g). By comparing these contour lines, the commodity-detecting module 52 detects the commodity G in the frame image FI(m). Here, m and g represent positive integers.

The frame image FI(m-g) is a reference image. The reference image is acquired before detection of change in the brightness by the image-retrieving module 51. This timing is effective at the site where there is little change in the background, such as in the case when the picture of the upper surface of the counter 151 is shot by the image sensor 164. The reference image may be stored beforehand in the RAM 163.

When there is a significant change in the background, the reference image may be acquired right after the last round of treatment of the object recognition engine. When the operator changes frequently, such as in the case of self-checkout or the like, this timing is effective. This is because the position of commodity G on the commodity reader 101 depends on the specific operator. The timing for acquiring the reference image may be set at will by the user.

The commodity-detecting module 52 may also detect the commodity on the basis of the color of the hands of the operator. As the commodity-detecting module 52 detects the skin color region from the frame image, the commodity-detecting module 52 has the skin color region and its vicinity of the frame image converted to binary data and extracts the contour line. With the contour line, the commodity-detecting module 52 detects the contour of hand and the contour of the other objects, separately. The commodity detecting module 52 then judges that the object is the commodity G.

The similarity-calculating module 53 acquires a portion or the entirety of the commodity G contained in the frame image based on the reference value. The similarity-calculation module 53 may acquire areas which have higher brightness than the reference value in the frame image. The similarity-calculation module 53 may also change the brightness of each pixel which is lower than the reference value into the lowest or the darkest brightness. The similarity-calculating module 53 may also acquire the image data on the inner side of the contour line extracted by the commodity-detecting module 52. On the basis of the acquired image, the similarity-calculating module 53 calculates a characteristic quantity data A. The characteristic quantity data A is calculated without considering the contour line, the size, etc. This reduces the load of the CPU 161.

The similarity-calculating module 53 calculates the characteristic quantity data B from the commodity image of the PLU file F1. The similarity-calculating module 53 compares the characteristic quantity data A with the characteristic quantity data B to calculate the similarity. When two characteristic qualities entirely identical to each other are compared, the similarity is defined as 100% or 1.0. The similarity-calculating module 53 carries out the weighting process with respect to the factors of hue, bumps/dips of surface, and surface pattern to calculate the characteristic quantity. This characteristic quantity is the absolute evaluation.

The technology for recognition of the object from the image data is called “Generic Object Recognition”. The “Generic Object Recognition” is explained in the following two references:
Kenji Yanai, “The Current State and Future Directions of Generic Object Recognition,” Transactions of Information Processing Society of Japan, Vol. 48, No. SIG16 (retrieved on Aug. 10, 2010 at: http://mm.cs.uec.ac.jp/IPSJ-TCVIM-Yanai.pdf); and
Jamie Shotton et al., “Semantic Texton Forests for Image Categorization and Segmentation”, (retrieved on Aug. 10, 2010 at: http://citeseerx.ist.psu.edu/viewdoc/download?doi=10.1.1.145.3036&rep=rep1&type=pdf).

Each of the foregoing references is hereby incorporated by reference as if set forth herein in their entirety.

The first embodiment of the present disclosure uses the relative evaluation as the similarity comparison. For example, when the PLU file F1 has the records of 5 different commodities, the similarity-calculating module 53 compared the commodity G with the commodity images of the 5 records, and it calculates the various similarities as the absolute evaluation. The various similarities are GA, GB, GC, GD, and GE. The relative evaluation of the similarity, for example, is calculated by the logic of GA/(GA+GB+GC+GD+GE).

For example, the similarity determining module 54 judges the similarity calculated for each frame image on the basis of three thresholds. In this embodiment, the threshold is set at, but not limited to, 90%, 75%, and 10%. The level 1 has threshold of 90% or higher. The level 2 is in the range from about 75% to about 90%. The level 3 is in the range from about 10% to about 75%. The similarity determining module 54 judges the condition that meets the similarity. The level 1 has the highest similarity, and the level 3 has the lowest similarity.

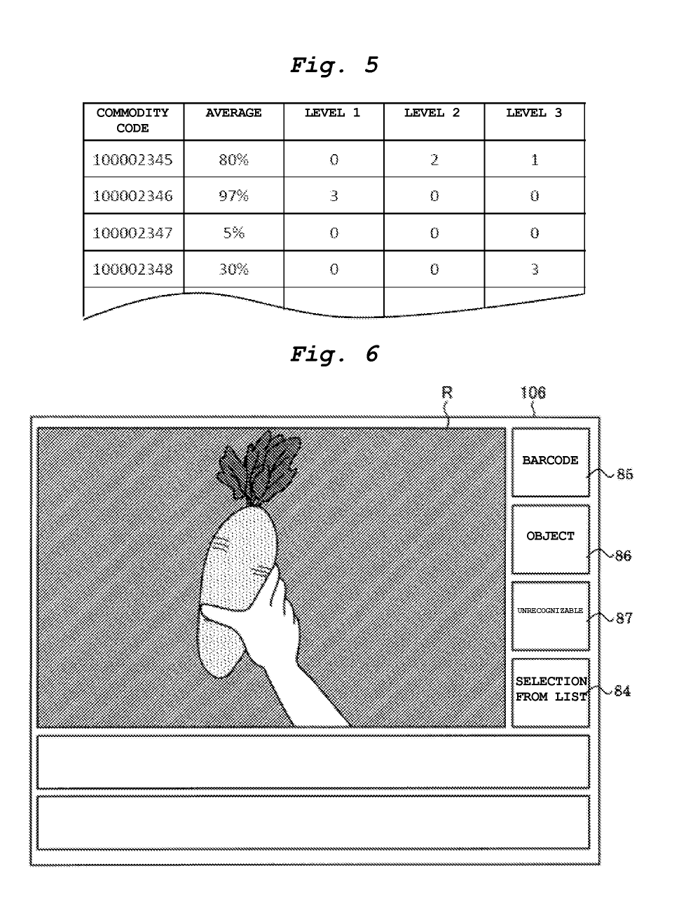

The similarity determining module 54 records the determination result for each commodity ID in the check table. The check table is stored in the RAM 163. FIG. 5 shows the arrangement of the check table in the first embodiment. This check table is described in the SQL language, and it holds the fields of the commodity code, the average, the level 1, the level 2, and the level 3. The field on levels 1 to 3 has the initial value of 0. The commodity code is the principal key. The average field stores the average value of the similarity.

The similarity-calculating module 53 compares the frame image FI(m) with the commodity images of all of the records of the PLU file F1. The similarity-calculating module 53 then sends the commodity codes of all of the records and the similarity to the similarity determining module 54. The similarity determining module 54 describes the commodity codes and the determination results in the check table. For example, suppose the similarity of the commodity code “100002346” is 95%, 1 is added to the field on level 1 of the record of the commodity code “100002346”. The field value of the condition 1 of the commodity code “100002346” is 1. Then, for the frame image FI(m+1), the similarity-calculating module 53 calculates the similarity. Suppose the similarity of the commodity code “100002346” is 93%, 1 is added to the field on level 1 of the record of the commodity code “100002346”. The field value on level 1 of the commodity code “100002346” becomes 2. The field value on level 1 essentially functions as a counter.

The similarity determining module 54 also has the determination conditions for 3 commodities. As condition A, there exists a record when the field value on level 1 is 2 or larger. As condition B, there exists a record when the field value on level 2 is 1 or larger. As condition C, there exists a record when the field value on level 3 is 1 or larger. The condition 1 has the highest priority order. The condition 2 has the second highest priority order. The condition 3 has the third highest priority order. The condition of the field value can be changed by the user.

According to the first embodiment, the similarity determining module 54 makes determinations on the basis of, but not limited to, the 3 conditions and the 3 levels. The condition and the level number can be changed by the design idea and the setting.

The deciding module 50 receives the established condition and the commodity code from the similarity determining module 54. On the basis of the received commodity code, the deciding module 50 acquires the record of the PLU file F1. The deciding module 50 checks whether the reference value-changing module 59 decreases the reference value of the brightness. When the reference value-changing module 59 does not decrease the reference value of the brightness, the deciding module 50 judges that the received commodity code is correct. When the reference value-changing module 59 decreases the reference level of the brightness, the deciding module 50 takes the field value of the density flag of the acquired record as a reference. When the field value of the density flag is 1, the deciding module 50 judges that the received commodity code is correct. When the field value of the density flag is 0, the deciding module 50 judges that the received commodity code is incorrect.

The deciding module 50 can omit the treatment in taking the density flag as a reference corresponding to the type of the received condition. The deciding module 50 can judge from the commodity image whether the surface of the commodity has a dark color.

On the basis of the commodity code sent from the deciding module 50, the extracting module 56 acquires the corresponding record from the PLU file F1. On the basis of the sent commodity code, the extracting module 56 sends the information about which type of GUI is generated for the notifying module 55.

The notifying module 55 generates the Graphical User Interface (GUI) on the basis of the information from the extracting module 56. The display device 106 displays the GUI. The notifying module 55 outputs the predetermined sound to the sound output part 165 corresponding to the type of GUI. The notifying module 55 sends a commodity code to the deciding module 50 on the basis of the user's selection.

The input module 57 receives the position information, etc. from the touch panel 105. The input module 57 sends the position information, etc. to the notifying module 55. On the basis of the position information, etc., the notifying module 55 specifies one commodity code. The output module 58 sends the established commodity code specified by the notifying module 55 to the POS terminal. The output module 58 may also send the commodity name or other information (instead of the commodity code) that can specify the commodity to the POS terminal.

The program executed by the CPU 61 of the POS terminal 11 includes the sales registration module 611. The sales registration module 611 carries out sales recognition on the basis of the commodity code received from the notifying module 55 and the number data input from the keyboard 107. The sales registration module 611 acquires the corresponding record from the PLU file F1 on the basis of the received commodity code. The sales registration module 611 records the record in the sales table. The sales registration module 611 calculates the total amount of the transaction and the change on the basis of the data in the sales table, and outputs the receipt data to the printer 66.

FIG. 6 is a diagram illustrating the default GUI of the first embodiment. The notifying module 55 generates the GUI before starting the object recognition engine. The GUI is displayed on the display device 106. The default GUI has an area R that displays the frame image. Plural buttons are arranged adjacent to the area R. The button 84 outputs the call signal for the list for selecting the commodity. The operator can specify the commodity from this list.

The button 85 outputs the signal to the CPU 161, instructing it to read a barcode on the commodity. With the barcode scanner or a wireless tag scanner (not shown in the figure), the barcode is converted to the commodity code. The button 85 also can output the signal for starting the barcode read-only recognition engine, which is different from the object recognition engine described herein. However, the barcode scanner and the object recognition engine described herein may be implemented in the same hardware.

The button 86 outputs a signal to the CPU 161, instructing it to start the object recognition mode, which will be explained later. The button 87 outputs the signal to the CPU 161, instructing it to start the reference value changing module 59. When the commodity reader 101 does not work even when the commodity is set near the reading window 103, the operator presses the button 87.

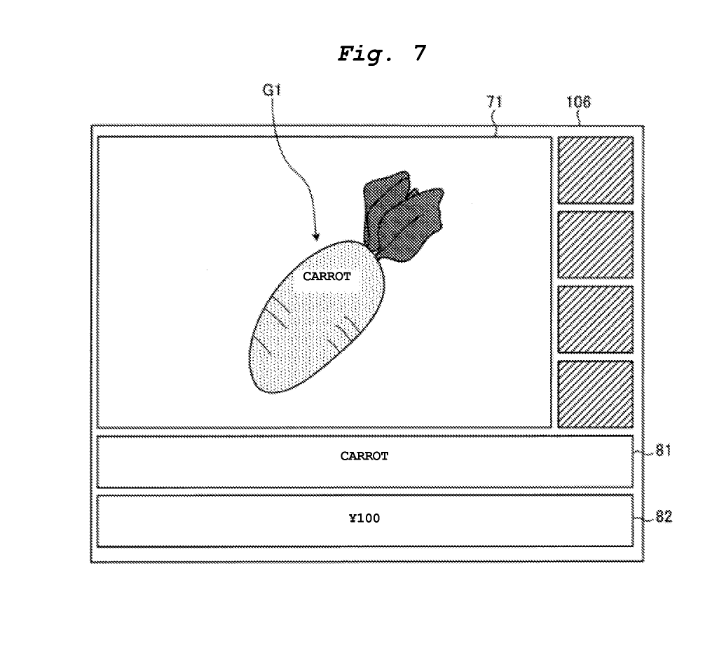

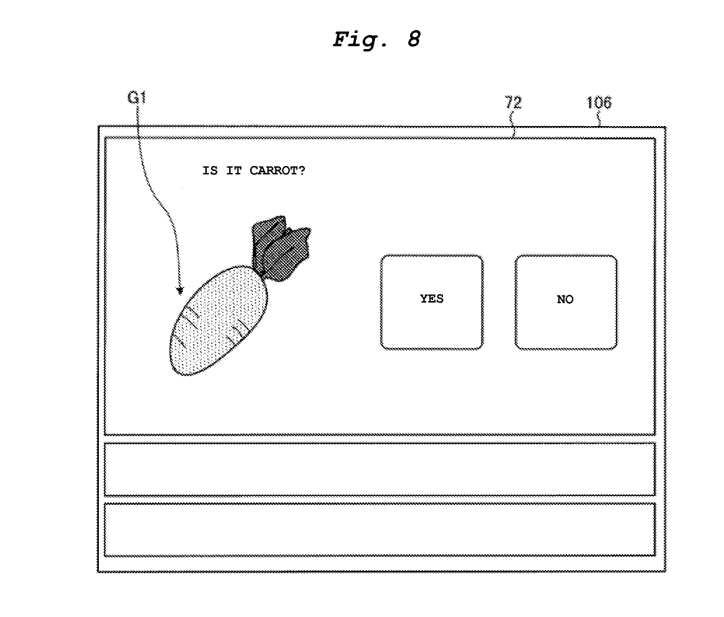

FIG. 7 shows the GUI indicating that the commodity is determined in the first embodiment. The determination GUI has area 71, area 81, and area 82. The area 71 is an area representing the illustrated image. The area 81 is an area for displaying the commodity name. The area 82 is an area for displaying the unit price. When the data received from the deciding module 50 is condition A, and the number of the commodity code received from the extracting module 56 is 1, the notifying module 55 generates the GUI. From the extracting module 56, the notifying module 55 receives the illustrated image G1, the commodity name, and the unit price, and these data are added to the area of the GUI. The notifying module 55 may also receive the commodity image instead of the illustrated image.

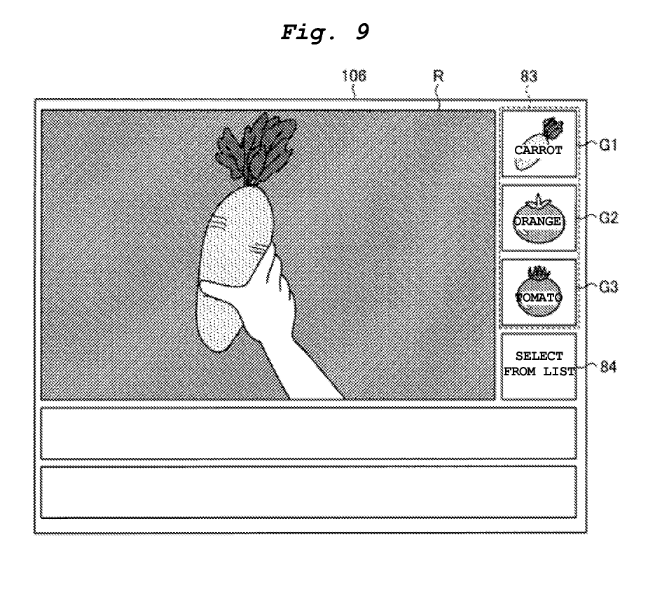

FIG. 8 is a diagram illustrating the GUI for requesting the operator to carry out the determination in the first embodiment. This confirmation GUI has the area 72, which includes the illustrated image G1, the announce data and plural buttons. When the data received from the deciding module 50 is condition B and the number of the commodity code received from the extracting module 56 is 1, the notifying module 55 generates the GUI of FIG. 8. The notifying module 55 receives the illustrated image G1 from the extracting module 56, then adds the illustrated image G1 to the area 72. The announce data is output (in the form of a question, for example) soliciting confirmation from the operator that the image of the area 72 is the commodity shown in illustrated image G1. The button has the function of accepting input from the operator. When the illustrated image G1 is correct, the operator presses the button “YES”. On the other hand, when the illustrated image G1 is incorrect, the operator presses the button “NO”. With input from the operator, the commodity code is determined.

FIG. 9 is a diagram illustrating the GUI for requesting the operator to make a selection according to the first embodiment. This GUI has area R, area 83, and button 84. The area 83 has bottoms G1, G2, and G3. The condition received from the deciding module 50 may be any of conditions A, B, and C. When the number of the commodity code received from the extracting module 56 is more than 1, the notifying module 55 generates the GUI of FIG. 9. The notifying module 55 receives the plural illustrated images from the extracting module 56, and the illustrated images are added by the buttons G1, G2, and G3. Instead of the illustrated images, one may also adopt a scheme in which the notifying module 55 attaches the commodity names to buttons G1, G2, and G3.

The notifying module 55 adds the illustrated image of the commodity code with the highest similarity to the button G1. The notifying module 55 then displays the illustrated images of the commodities in the descending order of similarity on the GUI. The operator then selects anyone of the buttons G1, G2, or G3. Upon selection made by the operator, one commodity code is determined.

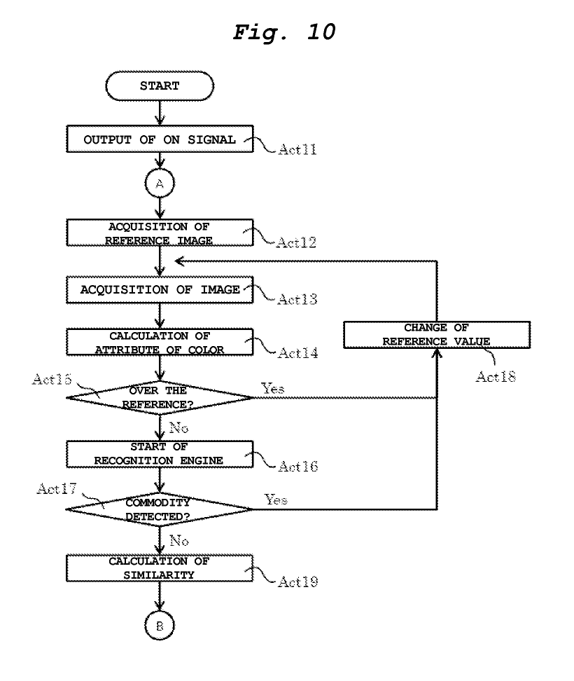

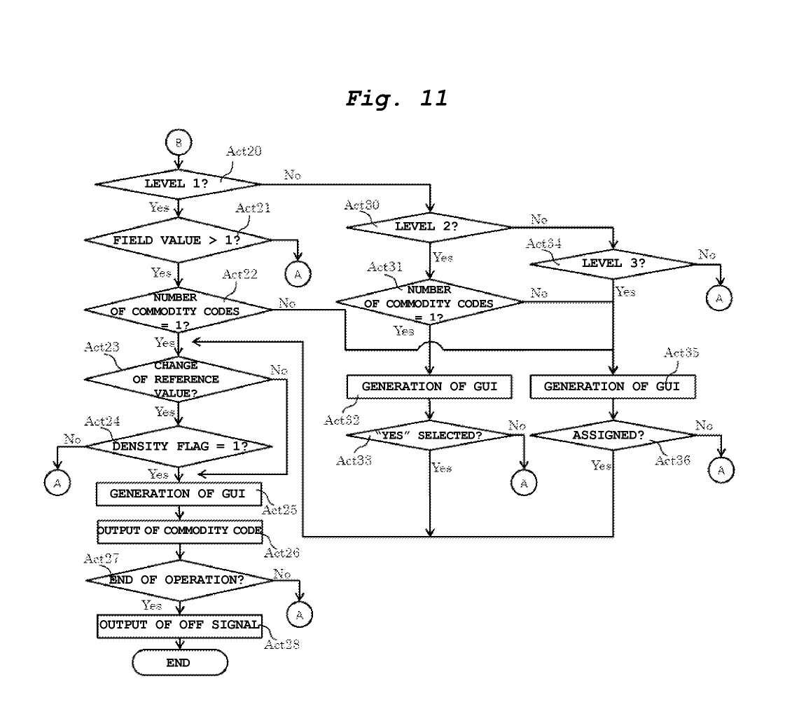

FIGS. 10 and 11 are a flow chart showing execution of the commodity reader in the first embodiment. The CPU 161 of the commodity reader 101 starts the reading operation. The image-retrieving module 51 sends the ON signal to the image sensor 164 (Act 11). The image sensor 164 generates the frame images at the prescribed frame rate and stores them in the RAM 163. The image-retrieving module 51 then acquires the frame image FI(m-g) stored in the RAM 163 and sets it as the reference image (Act 12).

The image-retrieving module 51 acquires the frame image FI(m) from the image sensor RAM 164 (Act 13). The image-retrieving module 51 calculates the value of the color attribute of the frame image FI(m) (Act 14). In the first application example, among the color attributes, the adopted color attribute is, but is not limited to, the brightness. The image-retrieving module 51 judges whether the value of the brightness is greater than a prescribed reference value (Act 15). If the brightness value is less than the prescribed reference value, the image-retrieving module 51 changes the brightness value to the prescribed reference value (Act 18). If the brightness value is greater than the prescribed reference value, the CPU 161 starts the object recognition engine (Yes in Act 15, Act 16). The reference value-changing module 59 judges whether the commodity-detecting module 52 detected the commodity G is detected from the frame image FI(m) (Act 17). If no commodity G is detected by the commodity-detecting module 52, the reference value changing module 59 changes the prescribed reference value (Act 18). The image-retrieving module 51 then acquires the frame image FI(m+1) from the RAM 163 (Act 13).

When the commodity-detecting module 52 detects the commodity G, the similarity-calculating module 53 calculates the characteristic quantity of the frame image FI(m) (Act 19). The similarity-calculating module 53 then compares the characteristic quantity with the characteristic quantities of the commodity images of the various records of the PLU file F1. The similarity-calculating module 53 calculates the similarity with the commodity images of the various records and sends the commodity codes and the similarity values to the similarity determining module 54.

The similarity determining module 54 generates the check table on the basis of the commodity code and the similarity. When transmission of data by the similarity-calculating module 53 for the frame image FI(m) ends, the similarity determining module 54 takes all of the records of the check table as reference. The similarity determining module 54 searches the records having the field values on level 1 of 1 or larger (Act 20). When a record with field value on level 1 other than 0 is retrieved, the similarity determining module 54 sends the commodity code of the retrieved record to the deciding module 50. Then, the deciding module 50 checks whether the field value of the commodity code is greater than the prescribed count value 1 (Act 21). The prescribed count value is a value that can be changed. When the field value is 1, the CPU 161 starts the Act 12. The check table is refreshed by the treatment of Act 12 and thereafter.

When the field value is greater than 1, the deciding module 50 checks whether there is one commodity code received from the similarity determining module 54 (Act 22). If the number of the received commodity codes is 2 or more, the CPU 161 executes the Act 35.

When the number of the received commodity codes is 1, the deciding module 50 checks whether the reference value of the brightness was changed by the reference value-changing module 59 (Act 23). If the reference value was not changed, the deciding module 50 sends 1 commodity code to the extracting module 56. The CPU 161 executes the Act 25.

When the reference value was changed, the deciding module checks the field value of the density flag of the corresponding record from the PLU file F1 on the basis of the commodity code kept by the similarity determining module 54 (Act 24). If the field value of the density flag is 0, the deciding module 50 judges that the result of the similarity determining module 54 is incorrect. The CPU 161 discards the check table and executes the Act 12.

When the field value of the density flag is 1, the deciding module 50 judges that the result of the similarity determining module 54 is correct. The deciding module 50 sends one commodity code to the extracting module 56. On the basis of the fact that only one commodity code is received, the extracting module 56 reads the record corresponding to this one commodity from the PLU file F1. Then, the extracting module 56 sends the request for display of the deciding GUI and the record to the notifying module 55. The notifying module 55 then generates the deciding GUI as shown in FIG. 7, and displays it on the display device 106 (Act 25). The notifying module 55 then outputs the sound indicating determination of the commodity from the sound output part 165.

The output module 58 sends the determined commodity code to the POS terminal 11 (Act 26). A scheme may be implemented in which the output module 58 writes the commodity code in the registration table of the RAM 163. A scheme may also be implemented in which, at the end of all of the scanning operations, the output module 58 sends all of the commodity codes in the registration table en bloc to the POS terminal 11.

When there are plural commodities with the same determined commodity code, the operator uses the keyboard 107 to input the number. The output module 58 sends the number information together with the commodity code to the POS terminal 11.

The CPU 161 checks whether the end signal indicating completion of all of the scanning operation is received from the keyboard 107 (Act 27). When this end signal is not received, the CPU 161 resets the check table, and after the reference value is reset to the default value, it starts the treatment of Act 12. When the end signal is received, the image-retrieving module 51 sends the OFF signal to the image sensor 164.

When Act 20 is “No”, the similarity determining module 54 takes all of the records of the check table as reference. The similarity determining module 54 checks whether there is a record having a field value on level 2 of 1 or greater (Act 30). If a record having the field value of 1 or greater on level 2 is found, the similarity determining module 54 sends the commodity code corresponding to the searched record to the deciding module 50.

The deciding module 50 checks where the number of the commodity codes received from the similarity determining module 54 is 1 (Act 31). When the number of the received commodity codes is 2 or more, the CPU 161 executes the Act 35. When the number of the received commodity codes is 1, the deciding module 50 sends the one commodity code and the flag on level 2 to the extracting module 56. On the basis of the received commodity code, the extracting module 56 extracts the corresponding record from the PLU file F1. The extracting module 56 sends the display request of the confirmation GUI and the record to the notifying module 55. The notifying module 55 generates the confirmation GUI shown in FIG. 8, and displays it on the display device 106 (Act 32).

The notifying module 55 stands by to await selection of the button of “YES” or “NO” by the operator (Act 33). When the input module 57 detects that the “YES” button is pressed, the notifying module 55 sends one commodity code to the deciding module 50. The deciding module 50 executes the Act 23. Alternately, when the input module 57 detects that the “NO” button is pressed, the CPU 161 executes the Act 12.

When the Act 30 is “NO”, the similarity determining module 54 takes all of the records of the check table as reference. The similarity determining module 54 judges whether there is a record having a field value on level 3 of 1 or greater (Act 34). When a record with a field value of 1 or greater is found on level 3, the similarity determining module 54 sends the commodity code corresponding to the searched record to the extracting module 56. When there is no record with the field value on level 3 of 1 or greater, the CPU 161 executes the Act 12.

On the basis of the received commodity code, the extracting module 56 extracts the corresponding record from the PLU file F1. The extracting module 56 sends the request for display of the selection GUI and the record to the notifying module 55. The notifying module 55 generates the selection GU, as shown in FIG. 9, and displays it on the display device 106 (Act 35). The notifying module 55 than stands by to await the operator's selection of any of the buttons G1, G2, and G3 of the area 83 (Act 36). When the input module 57 detects that one of the buttons G1, G2, G3 is pressed, the notifying module 55 sends the one commodity code corresponding to the selected button to the deciding module 50.

The first embodiment is not limited to the case when the commodity reader 101 treats the commodities one by one. It is also possible treat plural commodities at the same time. In this case, the frame image contains plural commodities. For example, the commodity reader 101 divides them to plural commodity regions by edge detection.

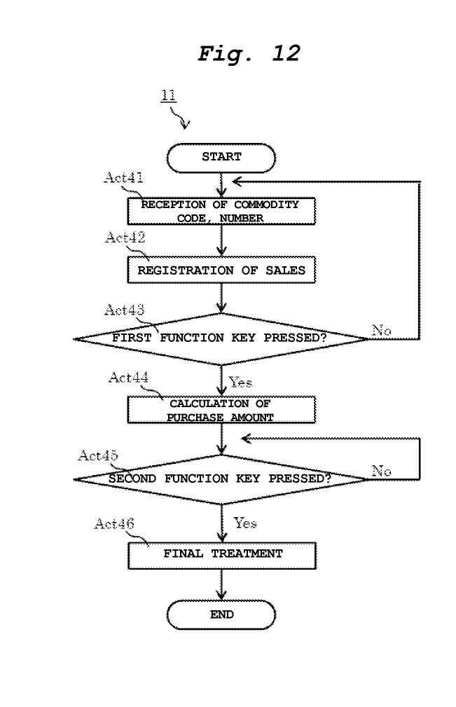

FIG. 12 is a treatment flowchart illustrating execution of the CPU 61 of the POS terminal 11 in the first embodiment. The POS terminal 11 receives the commodity code and the number information from the commodity reader 101 (Act 41). The sales registration module 611, a portion of the program PR, acquires the corresponding record from the PLU file F1 on the basis of the commodity code. The sales registration module 611 registers the commodity code, the commodity name, the unit price, and the number to the sales master file F2 (Act 42).

The CPU 61 checks whether the operator presses the first function key 22e (Act 43). The CPU 61 stands by to await reception of the commodity code until a signal is received from the first function key 22e. When the CPU 61 receives the signal from the first function key 22e, the sales registration module 611 calculates the purchase amount on the base of the sales master file F2 and displays it on the display device 24 (Act 44).

After the operator uses the ten-key 22d to input the amount paid by the customer, the CPU 61 receives the signal from the second function key 22f (Act 45). The sales registration module 611 compares the amount input by the ten-key 22d and the purchase amount to calculate the change. The sales registration module 611 generates the receipt data containing the information of sales master file F2, the purchase amount, and the change and sends the data to the printer (Act 46). The function of CPU 61 then comes to an end.

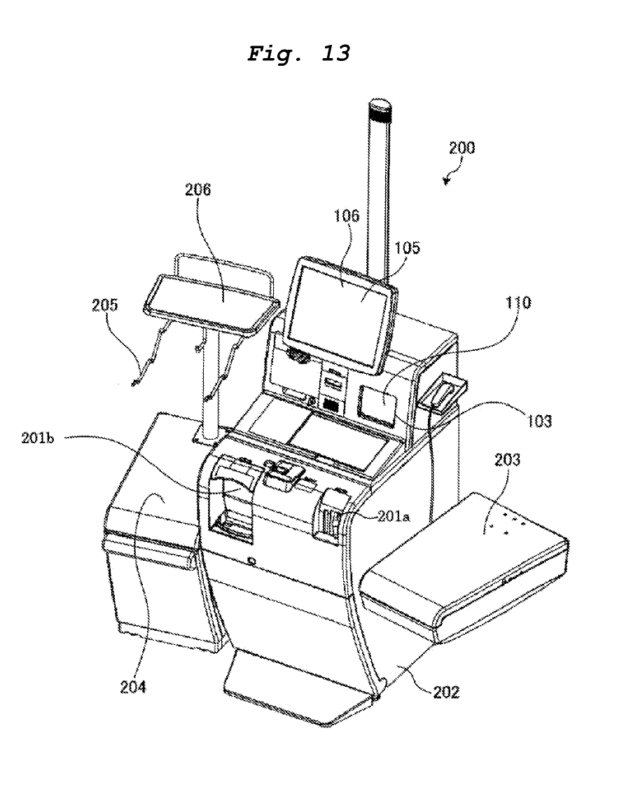

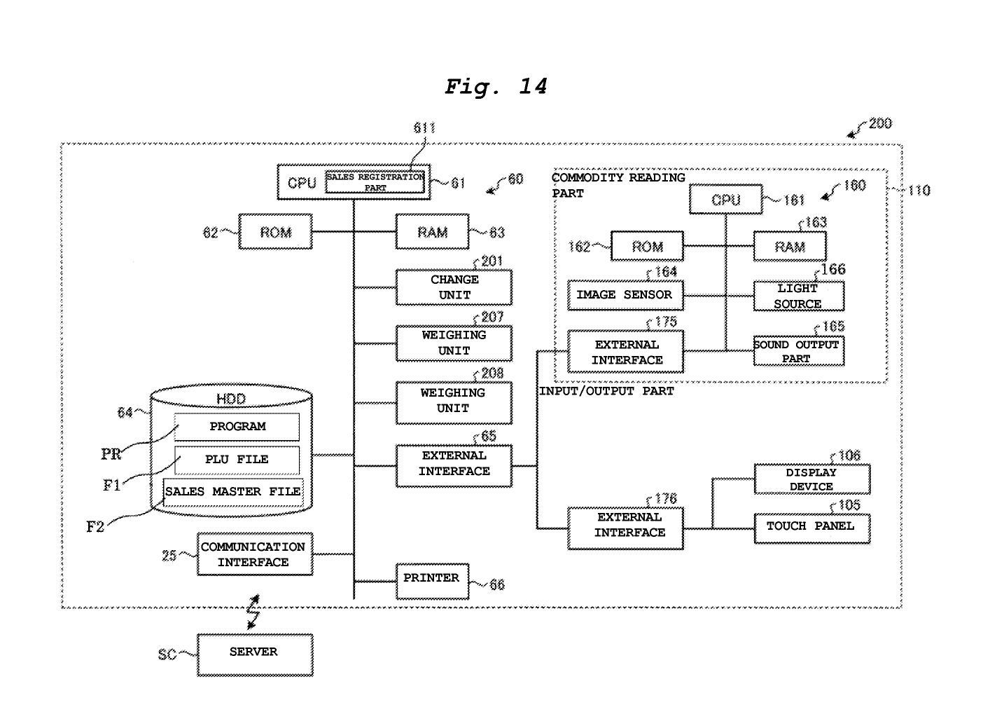

The second embodiment will be explained with reference to FIG. 13 and FIG. 14. FIG. 13 is a diagram illustrating the appearance of the self-checkout device 200 in the second embodiment. The self-checkout device 200 has a main body 202, a first table 203, and a second table 204. The main body 202 has a display device 106, a commodity reading unit 110, and a change unit 201.

The display device 106 has the touch panel 105 arranged on its surface. The display device 106 displays the guide for the customer, deciding GUI, confirmation GUI, selection GUI, and the GUI for debt settlement including selection of the payment method. The display device 106 displays the GUI including the functions of both the POS terminal 11 and the commodity reader 101 in the first embodiment.

The change unit 201 includes a cash loading unit 201a and a cash unloading unit 201b. The cash loading unit 201a receives the cash from the customer. The cash loading unit 201a also counts the amount and judges whether the cash is counterfeit. The cash unloading unit 201b gives out the change calculated by the CPU 61.

The first table 203 is arranged on the right-hand side of the main body 202. The customer sets the commodity before registration by the commodity-reading unit 110 on the first table 203. The first table 203 has a weighing unit 207 inside it. The customer sets the commodity registered by the commodity-reading unit 110 on the second table 204. The second table 204 has a weighing unit 208 inside it. The customer sets the soft commodity on the table 206. The hook 205 holds the arm of the register bag. The table 206, together with the hook 205, is connected to the second table 204. The weighing unit 208 can measure the weight of the commodity set on the second table 204 and on the table 206.

FIG. 14 is a block diagram illustrating the hardware of the self-checkout device 200. Here, the CPU 61 has the change unit 201 and the weighing units 207 and 208 connected to it. The first and second function keys, the ten-key 22d, and the keyboard 107 in the first embodiment are displayed on the display device 106. The remaining features of the arrangement are the same as those of the first embodiment, and they will not be explained in detail again.

The programs of the commodity reader 101 in the first and second embodiments are independent of the hardware. For example, a portion or the entirety of the program may be executed by the server in a cloud network.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An article recognition system comprising:
an image sensor configured to capture an image of an article;
a determining module configured to determine a value indicative of darkness of the captured image and compare the determined value with a reference value;
a changing module configured to change the reference value when the determined value is less than the reference value; and
an extracting module configured to identify the article on the basis of the captured image when the determined value is greater than the reference value.

2. The article recognition system according to claim 1, wherein the changing module changes the reference value by changing an output of a light source that reflects light from the article to the image sensor.

3. The article recognition system according to claim 1, further comprising:
a similarity calculating module configured to compare a darkness level of the captured image to a darkness level in each of a plurality of stored image data and calculate similarity values, wherein the extracting module identifies the article on the basis of the calculated similarity values of the captured image.

4. The article recognition system according to claim 3, further comprising:
a database that holds a plurality of records, each record having a commodity code and a plurality of similarity levels corresponding to different similarity thresholds;
a second changing module that changes one of the similarity levels when one of the calculated similarity values is above the corresponding similarity threshold; and
the extracting module identifies the article on the basis of the similarity levels.

5. The article recognition system according to claim 4, further comprising:
a generating module configured to generate a graphical user interface on the basis of article identified by the extracting module, wherein a type of the graphical user interface generated is determined on the basis of a comparison of the similarity levels.

6. The article recognition system according to claim 5, wherein
the similarity levels comprise a first level having the highest corresponding similarity threshold and a second level having a corresponding similarity threshold lower than the first level, and
when the similarity value corresponds to the first level, the generating module generates a determination graphical user interface that indicates that the article is identified.

7. The article recognition system according to claim 6, wherein
when the similarity value corresponds to the second level, the generating module generates a confirmation graphical user interface that asks the user whether the identified article is correct.

8. The article recognition system according to claim 5, wherein
when the similarity value corresponds to similarity levels for multiple records, the generating module generates a selection graphical user interface that asks the user to select the article from among several reference commodities.

9. An article recognition system comprising:
an retrieving module configured to retrieve an image of an article captured by an image sensor;
a determining module configured to determine a value indicative of darkness of the retrieved image and compare the determined value with a reference value;
a changing module configured to change the reference value when the determined value is less than the reference value; and
an extracting module configured to identify the article on the basis of the retrieved image when the determined value is greater than the reference value.

10. The article recognition system according to claim 9, wherein the changing module changes the reference value by changing an output of a light source that reflects light from the article to the image sensor.

11. The article recognition system according to claim 9, further comprising:
a similarity calculating module configured to compare a darkness level of the captured image to a darkness level in each of a plurality of stored image data and calculate similarity values, wherein the extracting module identifies the article on the basis of the calculated similarity values of the captured image.

12. The article recognition system according to claim 11, further comprising:
a database that holds a plurality of records, each record having a commodity code and a plurality of similarity levels corresponding to different similarity thresholds;
a second changing module that changes one of the similarity levels when one of the calculated similarity values is above the corresponding similarity threshold; and
the extracting module identifies the article on the basis of the similarity levels.

13. The article recognition system according to claim 12, further comprising:
a generating module configured to generate a graphical user interface on the basis of article identified by the extracting module, wherein a type of the graphical user interface generated is determined on the basis of a comparison of the similarity levels.

14. The article recognition system according to claim 13, wherein
the similarity levels comprise a first level having the highest corresponding similarity threshold and a second level having a corresponding similarity threshold lower than the first level, and
when the similarity value corresponds to the first level, the generating module generates a determination graphical user interface that indicates that the article is identified.

15. The article recognition system according to claim 14, wherein
when the similarity value corresponds to the second level, the generating module generates a confirmation graphical user interface that asks the user whether the identified article is correct.

16. The article recognition system according to claim 13, wherein
when the similarity value corresponds to similarity levels for multiple records, the generating module generates a selection graphical user interface that asks the user to select the article from among several reference commodities.

17. An article recognition method, comprising:
obtaining an image of an article captured by an image sensor;
determining a value indicative of darkness of the captured image;
comparing the determined value with a reference value;
changing the reference value when the determined value is less than the reference value; and
identifying the article based on the obtained image when the determined value is greater than the reference value.

18. The method according to claim 17, wherein changing the reference value comprises changing an output of a light source that reflects light from the article to the image sensor.

19. The method according to claim 17, wherein changing the reference value comprises changing the reference value to the determined value.

20. The method according to claim 17, further comprising:
comparing the darkness value of the obtained image to a darkness level in each of a plurality of stored image data;
calculating a similarity value of the obtained image;
storing a database that holds a plurality of records, each record having a commodity code that corresponds to one of the stored image data and a plurality of similarity levels corresponding to different similarity thresholds; and
changing one of the similarity levels when one of the calculated similarity values is above the corresponding similarity threshold, wherein
identifying the article comprises identifying the article based on the similarity levels.
